(19) United States
(12) Patent Application Publication
(10) Pub. No.: US 2018/0313152 A1
(43) Pub. Date: Nov. 1, 2018

(54) Wedge Ladder Leveler

(71) Applicant: Peter Koeman, IV, Santa Cruz, CA (US)

(72) Inventor: Peter Koeman, IV, Santa Cruz, CA (US)

(21) Appl. No.: 15/498,500

(22) Filed: Apr. 27, 2017

(51) Int. Cl. E06C 7/44

(52) U.S. Cl. CPC E06C 7/44

(57) ABSTRACT

A ladder placement leveling device is easily stored for transport and used by firefighters to quickly and effectively level a fire service ladder put in service on uneven ground. The device is mounted for transport and storage to a ladder and does not impede use of an attached ladder when the device is attached to the ladder a storage positioned. The device includes a wedge, a strap and an assembly for attaching and looping the strap around a ladder rung. One element of the assembly forms a detachable attachment to the wedge. The assembly attaches to the wedge at each end of the detachably formed strap loop.

### BACKGROUND OF THE INVENTION

The present invention is designed to enable a user to level prior art straight and extension ladders placed into service on uneven ground. In certain applications, such as fire fighting, where time is of the essence, to include a real world fire ground environment where speed and efficiency are the most important factors to successful adder deployment, there is a long felt need for improved devices and methods for providing a stable positioning of a ladder on uneven ground.

Standard practice according to the International Fire Service Training Association advises that no ground ladder should be ascended without being reliably and stably supported from the ground; the method of the present invention addresses this object. The present invention takes a very simple shape adapted to the objective of leveling a ladder that has been placed into service on uneven ground.

There is currently no standard practice for leveling a ladder in the fire ground scenario, other than to pull the ladder towards the objective until both beams of the ladder touch firm ground surface. This prior art technique often places undo twisting stress on the ladder and applies forces to ladder beams that these ladders are not tested for.

While there are other leveling options on the market (e.g. U.S. Pat. No. 4,423,797, U.S. Pat. No. 6,336,521 & U.S. Pat. No. 5,542,497) these require permanent modifications to ladder, bulky add ons that are not conducive to how ladders are stored on fire department apparatus. These are quality products designed for the single craftsman who has the opportunity and ability to take the time to securely and stably position a ladder without haste.

### BRIEF SUMMARY OF THE INVENTION

The primary object of the method of the present invention is to provide an operator with a wedge ladder leveler that provides superior performance over prior art devices.

Another object of the method of the present invention present invention is to provide a wedge ladder leveler that can be placed into service with one hand, which allows the user or users to maintain control of a ladder while using the present invention to level said ladder.

An additional object of the method of the present invention present invention is to provide a wedge ladder leveler that can be attached to a prior art ladder without any permanent modifications to said ladder.

A further object of the method of the present invention present invention is to provide a wedge ladder leveler that can be stored on a prior art ladder in a ready to operate position without impeding use if the ladder is placed in service and the wedge ladder leveler is not needed.

Another object of the method of the present invention present invention is to provide a wedge ladder leveler that fits inside the footprint or original space of a prior art ladder, thus allowing the user to continue to store the prior art ladder in the original storage configuration.

Another object of the method of the present invention present invention is to provide a wedge ladder leveler that is designed with speed of operation when used in a fire ground environment where two or more persons are operating a prior art ladder as a trained team.

Another object of the method of the present invention present invention is to provide a wedge ladder leveler that is relatively simple to construct relative to the prior art thus keeping costs to an affordable amount.

### BRIEF DESCRIPTION OF THE DRAWINGS

FIG. 1 is a overall perspective from users point of view as if the left beam of a prior art ladder (hereinafter, the ladder”) was needing support from the invented wedge ladder leveler which is underneath the left side beam of ladder.

FIG. 2 is a close up view of the invented wedge ladder leveler of FIG. 1 to provide more detail.

FIG. 3 is side view of a ladder foot resting on the invented wedge ladder leveler of FIG. 1 and shows that the foot of the ladder sits in a groove on top of the invented wedge ladder leveler of FIG. 1 that stabilizes the ladder from lateral movement off the invented wedge ladder leveler of FIG. 1.

FIG. 4 is a side view of the invented wedge ladder leveler of FIG. 1 that provides detail seen in other drawings but also includes a strap that wraps around an upper ladder rung in one alternate mounting configuration.

FIG. 5 is top view of the invented wedge ladder leveler of FIG. 1 that shows an optional center cut groove and optional top strap anchors.

FIG. 6 shows the front view of the invented wedge ladder leveler of FIG. 1 stored in-between two rungs of the prior art ladder of FIG. 1.

FIG. 7 is a side cut away view that shows the invented wedge ladder leveler of FIG. 1 stored on the prior art ladder of FIG. 1 in-between two prior art ladder rungs.

### DETAILED DESCRIPTION OF THE INVENTION

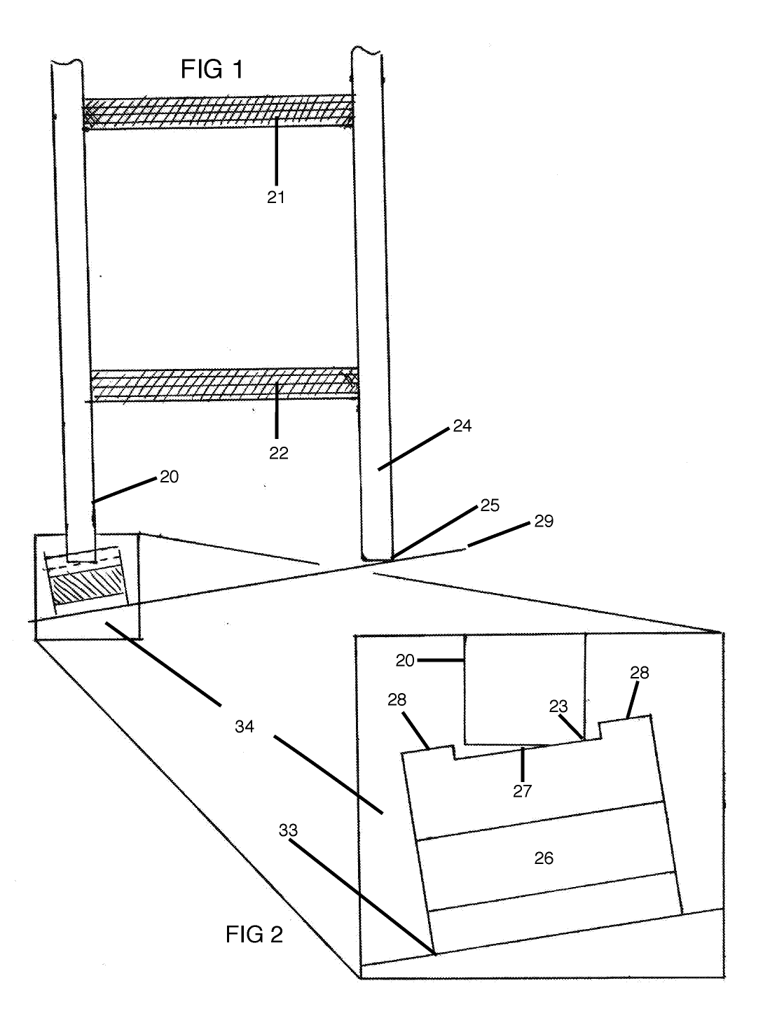

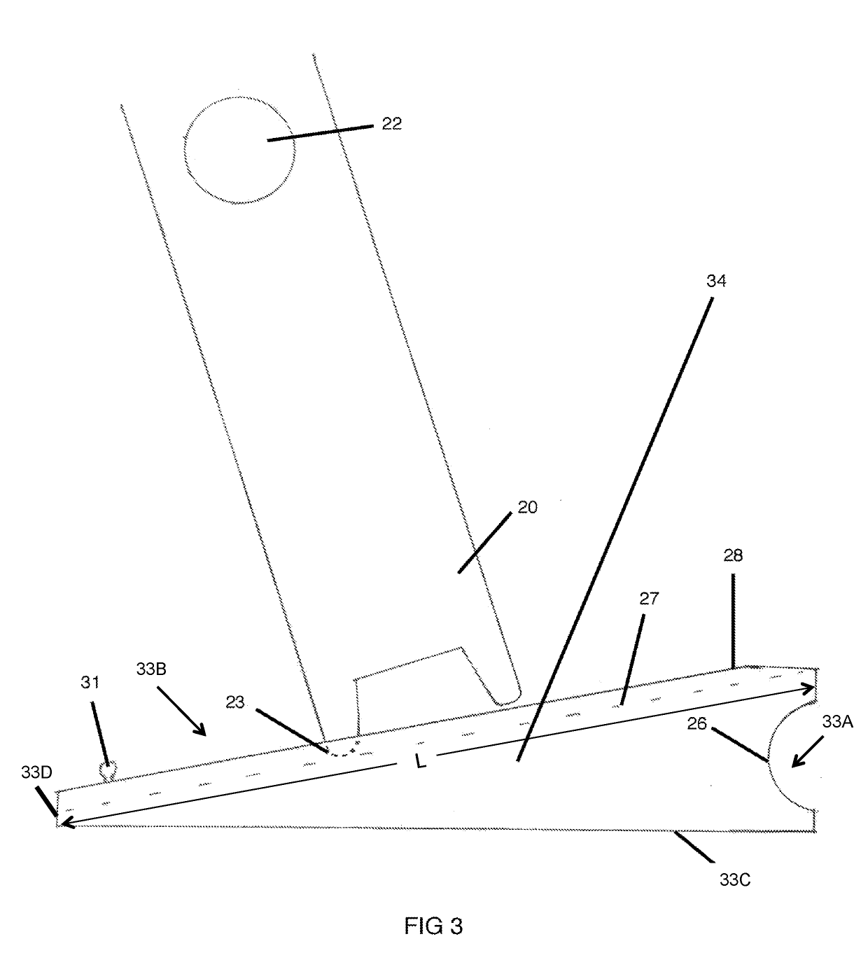

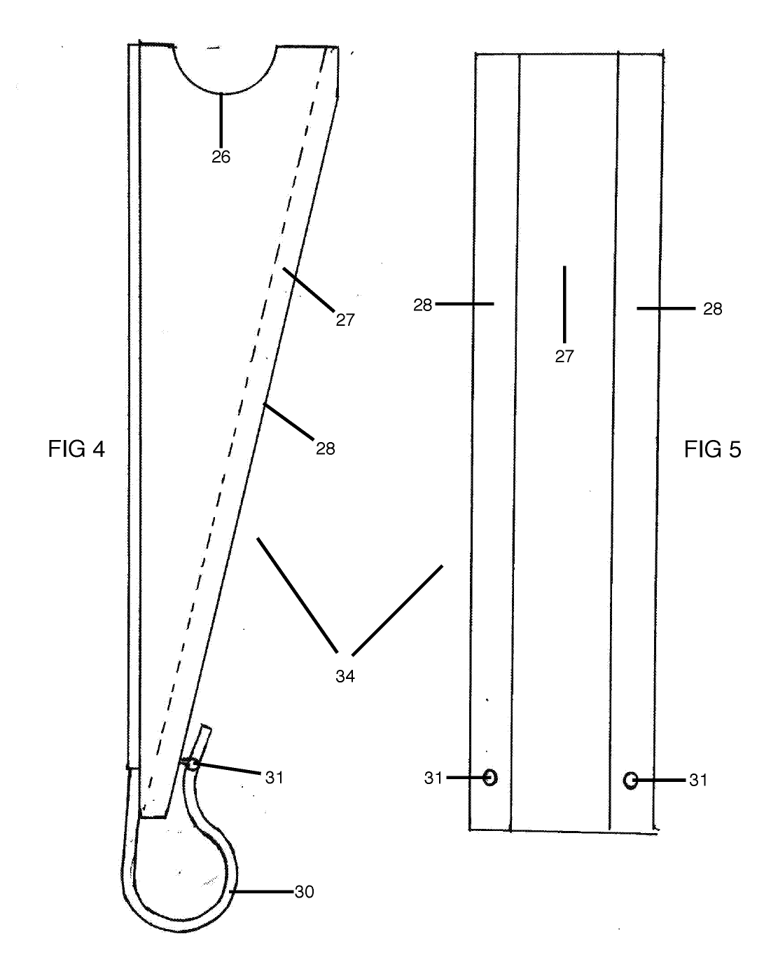

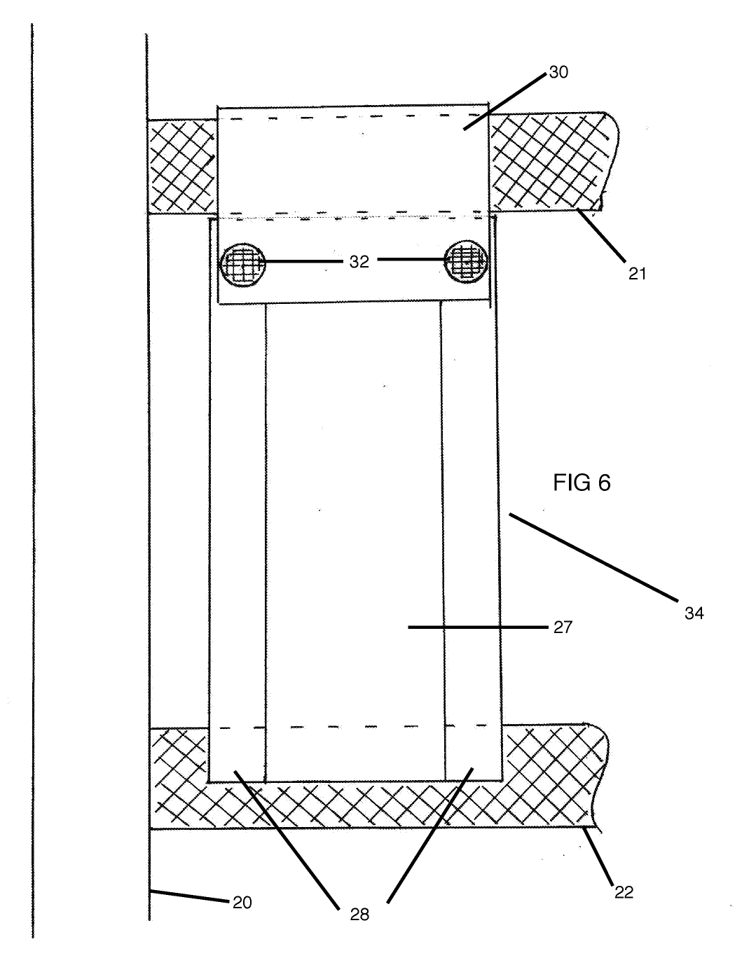

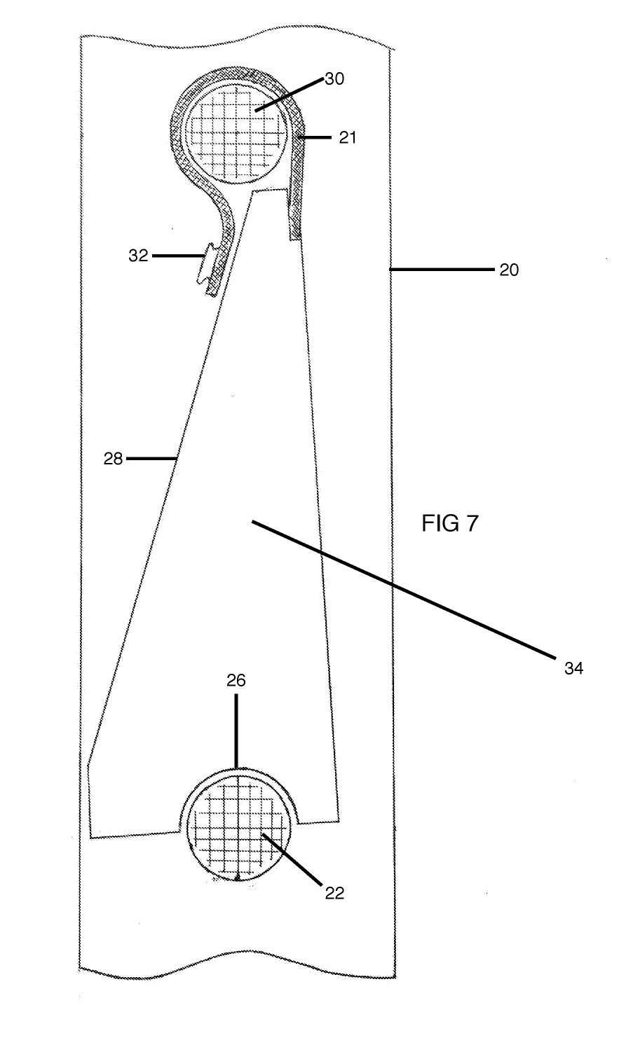

Turning now descriptively to the drawings in which similar reference characters denote similar elements throughout the five sheets of drawings. FIG. 1 through 3 show an invented wedge ladder leveler 34 in normal operation. FIGS. 4 and 5 show stand alone side and top views of the invented wedge ladder leveler 34 and include the drawing of an integrated strap 33 that helps store the invented wedge ladder leveler 34 when not in use. FIGS. 6 and 7 show the invented wedge ladder leveler 34 stored on a prior art ladder 24 between two rungs 21 & 22 with a front and a cut way side view.

FIG. 1 through 3 show the invented wedge ladder leveler 34 comprising a wedge comprising a milled piece of high density polyurethane 13.125″ long, 3.25″ wide and 3.125″ tall. The invented wedge ladder leveler 34 has design features including a 1.25″ diameter half circle cut out 26 that allows it to rest on a rung 21 & 22 in normal stored position. A full length 1.5″ wide, 0.375″ deep groove 27 cut down the top center of the invented wedge ladder leveler 34 to keep foot of the prior art ladder 24 from lateral movement off the device.

FIG. 4 shows a side view of the wedge ladder leveler 34, including the center top groove 27 and the radius cut in the back 26 with the integrated rung strap 30 that attaches to the strap anchors 31 that are attached to the upper rails 28 of the invented wedge ladder leveler 34. FIG. 5 is top view with different perspective of same characteristics. Center groove 27 is designed so any of the two most common manufactures fire service prior art ladders feet 25 can fit with minimal clearance to ensure stability.

FIG. 6 shows a front view of the wedge ladder leveler 34 in stored position on the prior art ladder 24 between upper rung 21 and lower rung 22. In the drawing the invented wedge ladder leveler 34 is shown mounted away from the ladder beam 20 just to show differentiation. With the preferred width of the invented wedge ladder leveler 34 the method of the present invention enables and allows the U.S. Federal Occupational Health and Safety approved space between rungs 21 & 22 while the invented wedge ladder leveler 34 is attached to the prior art ladder 24. FIG. 6 also illustrates the integrated top rung strap 30, with marine grade stainless steel quick release snaps 32 attached to the strap anchor studs 31 mounted to upper rails 28 of the invented wedge ladder leveler 34.

FIG. 7 is a side view cut away of the wedge ladder leveler 34 mounted in FIG. 6. The same characteristics and design elements remain as in FIG. 6 with the illustration of how the invented wedge ladder leveler 34 remains inside the volume or footprint of the prior art ladder 24. As was stated already, this was designed primarily for the fire service due to the fact that, it is my field of expertise. Ladder storage on fire apparatus allows for minimal clearance to keep prior art ladders 24 from moving too much in their brackets. The wedge ladder leveler's 34 ability to be attached to the prior art ladder 24 and be detachable and used when desired or needed is one key benefit of the method of the present invention.

The operation of the invented wedge ladder leveler 34 is based on simplicity and speed. When placing the prior art ladder 24 against an object on uneven ground a user would secure the prior art ladder 24 against the object with one hand and release the wedge ladder leveler 34 with the other hand. The user would then slide the invented wedge ladder leveler 34 under the ladder foot of the prior art ladder 24 that needed support until the wedge touched the prior art ladder 24 giving support off the firm surface that the other foot of the prior art ladder 24 rests on.

There are numerous designs for ladder levelers but they do not include the speed capabilities of the invented wedge ladder leveler 34. The other prior art items on the market are designed for a single craftsman to place into service and used for extended amounts of time. The method of the present invention relies on the standard operating principles of fire departments all over the country and that dictate that two or more personnel should operate a ground ladder when placed into service. The method of the present invention places a bigger safety factor on the extra firefighter using a prior art ladder 24, supported by the invented wedge ladder leveler 34 and provides tremendous reduction of speed of deployment.

To produce the wedge ladder leveler 34 one may apply an 18″ wedge of 3.5″×3.5″ douglas fir that has been milled down to the specifications disclosed in the FIGS. 1 through 7 and accompanying text. The wedge may alternatively comprise high density polyurethane. The integrated top rung strap 30 may comprise high quality leather with stainless steel hardware to add durability.

1. A device comprising:
a top side;
b) a ground side extending from the top side;
a ladder side extending from the top side and oriented at an acute angle in relation to the ground side proximate to the top side;
a bottom side positioned distally from the top side and between the ground side and the ladder side; and
a semi-circular cut-out formed in the bottom side, the cut-out shaped and positioned fit around a ladder rung.

2. The device of claim 1, further comprising a strap coupled to the ground side and to the ladder side proximate to the top side.

3. The device of claim 1, wherein the strap is sized, shaped and positioned to wrap around a ladder rung while the cut-out is positioned around another ladder rung of a same ladder.

4. The device of claim 1, wherein the strap is permanently attached to the ground side.

5. The device of claim 2, wherein the strap is detachably coupled to the ladder side.

6. The device of claim 1, wherein an inner arc of the cut-out is less than semi-circular.

7. The device of claim 1, wherein the ground side is planar.

8. The device of claim 1, wherein the ladder side is planar.

9. The wedge ladder leveler of claim 8, wherein the ground side is planar.

10. The device of claim 1, wherein the ladder side forms a groove extending in depth toward the ground side.

11. The device of claim 1, wherein a groove extends along an entire elongate length of the ladder side.

12. The device of claim 1, wherein a groove of the ladder side extends toward the top side and is oriented at an acute angle in relation to the ground side at the top side.

13. The device of claim 12, wherein the groove is planar.

14. The device of claim 12, wherein an inner arc of the cut-out is less than semi-circular.

15. The device of claim 12, wherein the ground side is planar.

16. The device of claim 12, wherein the groove is planar.

17. The device of claim 16, wherein the ground side is planar.

18. The device of claim 12, further comprising a strap coupled to the ground side and to the ladder side proximate to the top side.

19. The device of claim 1, wherein the acute angle formed between the ladder side and the ground side is less than 45 degrees.

20. The device of claim 1, wherein the acute angle formed between the ladder side and the ground side is less than 30 degrees.
